(19) United States
(12) Patent Application Publication
(10) Pub. No.: US 2004/0086020 A1
(43) Pub. Date: May 6, 2004

(54) Method and device for detecting altered physical and chemical properties in a liquid environment

(76) Inventor: Marlow C. Jordahl, Loveland, OH (US)

Correspondence Address: NEAL O. WILLMANN, 9521 MONTGOMERY ROAD, CINCINNATI, OH, 45242, US

(21) Appl. No.: 10/694,202

(22) Filed: Oct. 27, 2003

Related U.S. Application Data
(60) Provisional application No. 60/421,620, filed on Oct. 28, 2002.

(51) Int. Cl. G01N 25/00

(52) U.S. Cl. 374/45

(57) ABSTRACT

A method and device for performing diagnostic analyses on a liquid system is capable of detecting physical and/or chemical changes within the system by noting temperature changes, typically increases, within the device. These temperature changes can be relayed to alert an operator of the change in physical and/or chemical properties within the system so that remedial action can be taken.

### FIELD OF THE INVENTION

The invention described and claimed herein is a method and device for performing diagnostic evaluations on static or flowing liquid media in open or closed systems The method and device of these diagnostic evaluations have applications in a variety of industries; however, each application has a common theme: Each application of the disclosed method and device benefits from the detection of physical and/or chemical changes in a closed liquid system. Typically, the disclosed method and device will, when appropriate, provide a warning indicating that conditions within the system have changed over time and during use, and that it is time for the operator of the system to take remedial action. In many instances, the appropriate remedial action may be no more than adding or changing the liquid in the system, or the required action may be more involved, such as when the system needs to be shut down for cleaning or replacement of parts.

### DESCRIPTION OF THE PRIOR ART

Patent art relevant to the method and device described and claimed herein includes U.S. Pat. 4,751,371, issued to Clinton on Jun. 14, 1988. The Clinton patent describes a temperature controller and alarm device for use with a cartridge heater for providing heat to the mold of an injection molding apparatus. In the Clinton device, the heater temperature is compared to a desired temperature and a signal proportional to the difference in temperatures is coupled to a comparator, which produces an output signal when the magnitude of a triangular signal exceeds the magnitude of the temperature difference signal causing the comparator to operate switches affecting the heating element. Visual and audible alarms are also provided with the Clinton device to indicate the occurrence of a variety of conditions. Notwithstanding the similarity of the Clinton disclosure to the method herein disclosed, there remains a need for a simpler, diagnostic procedure for liquid systems, as opposed to solid systems, e.g., plastic molds.

### SUMMARY OF THE INVENTION

In the most general terms, the diagnostic procedures to be performed according to the disclosed method using the elements of the illustrated device involve establishing normal temperature conditions within an open or closed liquid system and comparing that normal temperature with a change, typically, an increase, in temperature, thus indicating an altered state within the system. To perform the disclosed method, a device comprising a collector tube containing a heat source, a detection means for detecting a temperature change within the collector and variable output signal means to alert an operator of the system of the temperature change is introduced into a closed fluid system.

The objective of the disclosed method and device is to provide closed loop diagnostic or detection means for a fluid system. A more specific objective of the disclosed method and device is to provide a means for detecting physical and/or chemical changes in the liquid medium of a fluid system. Specific objectives of the disclosed method and device are to detect the deposition or accumulation of excessive mineral scale on the inner surfaces of a fluid system; the chemical deterioration of the liquid medium of a fluid system; and even the reduction and absence of the liquid medium in a fluid system.

By meeting these specific objectives, the disclosed method will provide a closed loop diagnostic procedure for the routine maintenance of equipment employing a liquid as the process medium. Implementation of the disclosed method of detecting altered states in a liquid system will result in lower maintenance and operational costs, improve safety, improve the quality of the product being processed in the system and increase the efficiency of the system process because the disclosed method is automated.

### BRIEF DESCRIPTION OF THE DRAWING

FIG. 1 is a schematic illustration of the elements of the method and device for detecting altered properties in a closed liquid environment.

### DESCRIPTION OF THE PREFERRED EMBODIMENTS

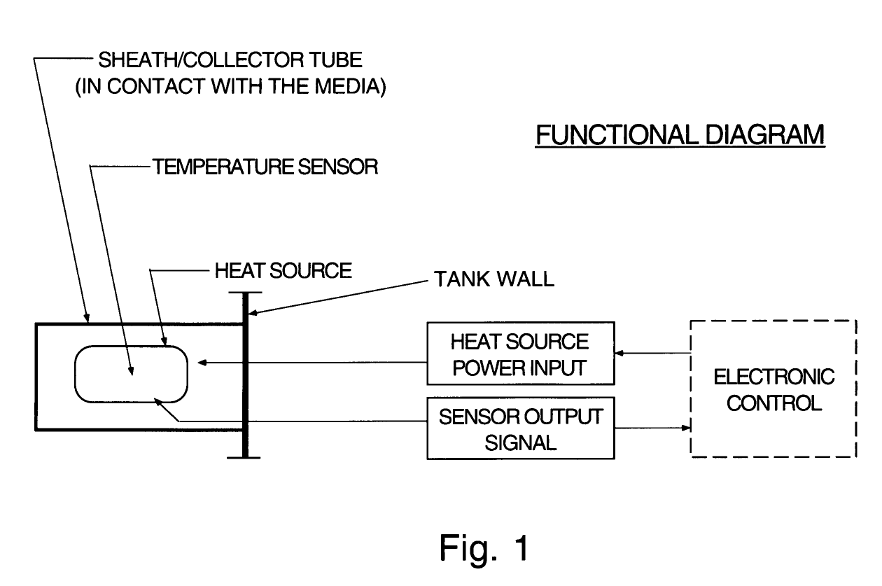

The method and device disclosed herein can be best described by referring first to the drawing. Essentially, what is illustrated in FIG. 1 is a device and method for conducting a closed loop diagnostic procedure in a liquid environment or system. The device comprises a collector tube containing a heat source and a detector. Temperature changes, typically increases, within the collector are measured and a variable output signal is generated. The signal is converted to generally recognized engineering units that indicate a changed condition.

The operating theory of the disclosed method and device is as follows: The heating element, or heat source within the collector/sheath, is used to establish a normal temperature within the collector. A physical or chemical change in the liquid system will alter that normal temperature, relative to the normal temperature in the collector, and it is the alteration in temperature that is detected and communicated in the form of the sensor output signal. This sensor output signal provides the operator with the information needed to initiate an appropriate response.

Generalized examples of physical or chemical changes that will alter the prevailing temperature of a fluid system include the deposition of mineral scale on the interior, or tank, walls of the system; fluid discoloration caused by heat stress; and a diminished quantity, or even a complete absence, of fluid in the system.

The sheath, or collector tube, is essentially a small container with an integral heat source and sensor. Any kind of conventional resistance-type heater is suitable for the heat source, and any kind of solid state electronic device, like PTC or NTC thermistors or thermocouples are suitable for use as the sensor. Ideally, the collector tube will contain multiple sensors to perform multiple functions.

The detection of an elevated temperature within the collector tube is noted by a sensor means in the collector tube. The sensor best suited for the detection of elevated temperatures is a PTC or NTC thermistor. These thermistors function as both heat sources and detection means. In those instances where it is advantageous to use separate heat detectors, the method could employ thermistors or RTDs for a variable resistance output or thermocouples for a variable voltage output.

The sensor output signal is any electronic element that processes a variable voltage or resistance signal to produce a suitable signal or alarm for alerting an operator of the elevated temperature within the collector tube.

The heat source and sensing means are positioned in the collecting tube, which is placed within the system and immersed in the liquid of the system. During operation of the system, the collector tube will accumulate or experience a build-up of solids, such as lime, scale or the like. The accumulated solids will act as an insulator and cause the temperature on the interior of the collector tube to increase. This increase in temperature will be detected by the sensor means, which, in turn, alerts the operator that the interior of the system has been compromised by the accumulation of scale, for instance. Clearly, the exterior of the collector tube will be representative of the interior of the system, and scale accumulation, for instance, on the collector tube will certainly indicate scale accumulation in the system. And scale accumulation in the system is an altered state worthy of early detection by the disclosed method and device. Detecting the early accumulation of scale will initiate remedial action thus preventing premature deterioration of electrical heating elements, fluid level controls and other system components that are prone to failure as a result of scale accumulation.

Systems containing fluid media that will benefit from the method and device of this disclosure are legion, but typical examples include dishwashers, especially those in commercial environments. Water heaters, both gas and electric, as well as boilers for the generation of steam will also benefit from any reliable method that can detect the early accumulation of scale. Small appliances such as coffee makers and steam tables in the restaurant industry can also be adapted to accommodate the disclosed device to alert the owner/operator of the need to take remedial action against the accumulation of scale.

In the instance or situation where the liquid of the fluid system is low or diminished, exposing the collector tube and its contents to air or the absence of fluid will elevate the temperature within the tube. The elevated temperature is, again, detectable and communicated to the signal means. The signal means will alert the operator to shut down and/or add fluid to the system.

Similarly, the liquid system that has been over-worked or over-heated will frequently “burn” or oxidize the fluid causing, at the very least, discoloration. The discoloration is typically evidenced as a darkening of the fluid in the system, and the “darkening” will create or cause an increase in temperature within the system. And this increase in temperature can be detected by the disclosed device and ultimately be communicated to the operator by the signal means. Ideally, the signal will advise the operator to change the fluid before damage in incurred by the system or, in the case of cooking oil, deleterious effects are visited upon the product being processed by the system.

While the foregoing is a detailed and complete description of the various embodiments of the disclosed method and the elements of the instrument for its implementation, it should be apparent that numerous variations and modifications can be made in the means, mode and method of the disclosed invention without departing from the spirit of the invention, which is fairly defined by the appended claims.

1. A method for the detection of an altered state in a system containing a liquid medium and a sensing device, said method comprising:
establishing a normal temperature of said sensing device;
detecting a change in the temperature of said sensing device;
comparing said change in temperature with said normal temperature; and
generating a signal to advise that said change in temperature exceeds a predetermined threshold, said signal indicating that the existence of an altered state is likely.

2. The method according to claim 1 wherein the altered state is a physical change.

3. The method according to claim 1 wherein the altered state is a chemical change.

4. The method according to claim 1 wherein the altered state is the accumulation of scale.

5. The method according to claim 1 wherein the altered state is a reduction in the quantity of liquid medium.

6. The method according to claim 1 wherein the altered state is the discoloration of the liquid medium.

7. The method according to claim 1 wherein the system is a dishwasher.

8. The method according to claim 1 wherein the system is a water heater.

9. The method according to claim 1 wherein the system is a boiler.

10. A device for the detection of an altered state in a system containing a liquid medium, said device comprising: a tube housing a heating means to establish and maintain the internal temperature of said tube; a temperature sensing means to monitor and detect changes in temperatures within the tube; and, a signal means to provide a signal indicating a temperature increase within the tube thereby alerting of the existence of an altered state.

11. The device according to claim 10 wherein the system containing a liquid medium is a dishwasher.

12. The device according to claim 10 wherein the system is a water heater.

13. The device according to claim 10 wherein the system is a boiler.

14. The device according to claim 10 wherein the altered state is the accumulation of scale.
